(19) United States
(12) Patent Application Publication
(10) Pub. No.: US 2026/0235736 A1
(43) Pub. Date: Aug. 13, 2026

(54) PHOTODETECTION DEVICE AND DISTANCE MEASURING SYSTEM

(71) Applicant: SONY SEMICONDUCTOR SOLUTIONS CORPORATION, KANAGAWA (JP)

(72) Inventors: GENKI NAGAMATSU, KANAGAWA (JP); NOBORU SAKIMURA, KANAGAWA (JP); YUJI INAGAKI, KANAGAWA (JP); AKITO SEKIYA, KANAGAWA (JP); NORIAKI ENDO, KANAGAWA (JP)

(21) Appl. No.: 19/155,502

(22) PCT Filed: Jan. 11, 2024
(86) PCT No.: PCT/JP2024/000440

§ 371 Date: Aug. 11, 2025

(30) Foreign Application Priority Data
Mar. 6, 2023 (JP) 2023-033864

(51) Int. Cl. G01S 7/4865; G01S 17/10

(52) U.S. Cl. CPC G01S 7/4865; G01S 17/10

(57) ABSTRACT

To mitigate deterioration of distance measurement accuracy while handling reflection of light from a plurality of objects.

A photodetection device includes: a time to digital converter (TDC) configured to measure a time of a light reception timing of a photon; and a histogram generation section configured to generate histograms having mutually different TDC resolutions in mutually different TDC code circulation periods of the TDC. The histogram generation section may generate two or more first histograms having mutually different TDC code circulation periods in a first distance measuring period, and may generate a second histogram having a TDC resolution coarser than that of the first histogram, in a second distance measuring period.

### TECHNICAL FIELD

The present technology relates to a photodetection device and a distance measuring system. Specifically, the present technology relates to a photodetection device and a distance measuring system capable of photodetection based on a plurality of time to digital converter (TDC) resolutions.

### BACKGROUND ART

In distance measurement, a time of flight (ToF) sensor may be used. In the ToF sensor, a distance to an object is directly measured on the basis of a light emission timing of light to the object and a light reception timing of light reflected from the object. For example, there has been proposed a distance measuring device that calculates a distance to an object from a histogram generated on the basis of a count value obtained by counting time from a light emission timing to a light reception timing with TDC resolutions different from each other (see, for example, Patent Document 1).

### CITATION LIST

### Patent Document

Patent Document 1: Japanese Patent Application Laid-Open No. 2021-1763

### SUMMARY OF THE INVENTION

### Problems to be Solved by the Invention

However, in the related art described above, when light is reflected from a plurality of objects, a distance measurement target cannot be specified, and there has been a possibility that distance measurement accuracy is deteriorated.

The present technology has been made in view of such a situation, and an object thereof is to mitigate deterioration in distance measurement accuracy while handling reflection of light from a plurality of objects.

### Solutions to Problems

The present technology has been made to solve the above-described problem, and a first aspect thereof is a photodetection device including: a time to digital converter (TDC) configured to measure a time of a light reception timing of a photon; and a histogram generation section configured to generate histograms having TDC resolutions that are mutually different in TDC code circulation periods of the TDC that are mutually different. As a result, an effect is provided that, when a subrange is set in a shorter one of the TDC code circulation periods, a peak of the histogram based on reflection of light from objects at mutually different distances can be uniquely discriminated by specifying each subrange in which each peak exists.

Furthermore, in the first aspect, the TDC may measure a time of light reception timings of the photons having mutually different light emission intervals. As a result, an effect is provided that a light emission interval of distance measurement light can be set according to a bin width of the histogram.

Furthermore, in the first aspect, the histogram generation section may generate two or more first histograms having, among the TDC code circulation periods, mutually different TDC code circulation periods in a first distance measuring period, and generate a second histogram having, among the TDC resolutions, a TDC resolution coarser than a TDC resolution of each of the first histograms, in a second distance measuring period. As a result, an effect is provided that a distance measurement range is expanded while an increase in load applied to generation of the histogram is restrained, and identification of a correspondence is enabled between a plurality of objects and a plurality of peaks of the histogram caused by a multipath.

Furthermore, in the first aspect, a light emission interval of distance measurement light in the first distance measuring period may be shorter than a light emission interval of the distance measurement light in the second distance measuring period. As a result, an effect is provided that a light emission interval according to a bin width of the first histogram having a fine TDC resolution is set while a restriction is relaxed in a light emission interval that is set according to a bin width of the second histogram having a coarse TDC resolution.

Furthermore, in the first aspect, a light emission interval of the distance measurement light in the first distance measuring period may be an integral multiple of each of the TDC code circulation periods for the first histograms. As a result, an effect is provided that the number of emitted photons is increased in the TDC code circulation period in the first distance measuring period.

Furthermore, in the first aspect, a bin width that is a TDC resolution of a histogram of the second distance measuring period may be equal to or smaller than each of the TDC code circulation periods for the first histograms. As a result, there is an effect that, when a subrange is set in a shorter one of the TDC code circulation periods, a peak of the histogram based on reflection of light from objects at mutually different distances can be uniquely discriminated by specifying each subrange in which each peak exists.

Furthermore, in the first aspect, a TDC code of the TDC may circulate a plurality of times within a distance measurement range in the first distance measuring period. As a result, an effect is provided that the first histogram having a fine TDC resolution is generated on the basis of a counting operation of the TDC.

Furthermore, in the first aspect, the TDC resolutions of the two or more first histograms may be equal to each other. As a result, an effect is provided that the TDC resolutions of the two or more first histograms are optimized.

Furthermore, in the first aspect, an upper limit of a bin width that is the TDC resolution of a histogram in the second distance measuring period may be a minimum value of the TDC code circulation periods for the first histograms. As a result, an effect is provided that a distance measurement range is expanded while an increase in load applied to generation of the histogram is restrained, and identification of a correspondence is enabled between a plurality of objects and a plurality of peaks of the histogram caused by a multipath.

Furthermore, in the first aspect, a lower limit of a bin width that is the TDC resolution of a histogram in the second distance measuring period may be a value obtained by dividing the distance measurement range by a maximum value of a number of bins of the second histogram. As a result, an effect is provided that the distance measurement range is enlarged while an increase in load applied to generation of the histogram is restrained.

Furthermore, in the first aspect, the first distance measuring period and the second distance measuring period may be set in a time-division manner.

As a result, an effect is provided that distances to two or more objects are calculated while a same circuit resource is allocated.

Furthermore, in the first aspect, a same circuit resource may be allocated to generation of the first histograms and generation of the second histogram. As a result, an effect is provided that distances to two or more objects are calculated while an increase in circuit resources is restrained.

Furthermore, in the first aspect, the first distance measuring period and the second distance measuring period may be set in parallel. As a result, an effect is provided that the number of distances that can be distanced is increased while an increase in the frame rate is restrained.

Furthermore, in the first aspect, separate circuit resources may be allocated to generation of the first histograms and generation of the second histogram. As a result, an effect is provided that generation of a plurality of histograms can be performed in parallel.

Furthermore, in the first aspect, at least one mode may be provided from among a frame rate priority mode in which a frame rate can be increased, a detectable peak number setting mode in which a number of detectable peaks can be increased, and a distance measurement range priority mode in which a distance measurement range can be expanded. As a result, an effect is provided that distance measurement can be performed while a distance measurement condition according to a distance measurement environment is optimized.

Furthermore, in the first aspect, a light emission interval of the distance measurement light may be changed for every subframe in at least one of the frame rate priority mode, the detectable peak number setting mode, or the distance measurement range priority mode. As a result, an effect is provided that a distance measurement range can be expanded on the basis of composite processing of subframes in which a light emission interval of the distance measurement light is changed.

Furthermore, in the first aspect, there may be further included a distance calculation unit configured to calculate a distance to an object on the basis of a histogram generated by the histogram generation section. As a result, an effect is provided that a distance to an object is calculated by measuring a time of a light reception timing of light reflected from the object.

Furthermore, in the first aspect, the distance calculation unit may calculate a distance to at least one object on the basis of the first histograms and the second histogram. As a result, an effect is provided that a distance measurement range is expanded while an increase in load applied to generation of the histogram is restrained, and identification of a correspondence is enabled between a plurality of objects and a plurality of peaks of the histogram caused by a multipath.

Furthermore, in the first aspect, a number of distances to an object that can be calculated by the distance calculation unit may be equal to or smaller than a number of the first histograms. As a result, an effect is provided that distances to two or more objects are calculated.

Furthermore, a second aspect is a distance measuring system including: a light emitting unit configured to emit a photon to an object; and a photodetection device configured to generate histograms having mutually different time to digital converter (TDC) resolutions in mutually different TDC code circulation periods of a TDC that measures a time of a light reception timing of a photon reflected from the object.

As a result, there is an effect that, when a subrange is set in a shorter one of the TDC code circulation periods, a peak of the histogram based on reflection of light from objects at mutually different distances can be uniquely discriminated by specifying each subrange in which each peak exists.

### BRIEF DESCRIPTION OF DRAWINGS

FIG. 1 is a block diagram illustrating a configuration example of a distance measuring device according to a first embodiment.

FIG. 2 is a block diagram illustrating a configuration example of a light detection unit according to the first embodiment.

FIG. 3 is a block diagram illustrating a configuration example of a solid-state imaging device to which the photodetection device according to the first embodiment is applied.

FIG. 4 is a diagram illustrating an example of a sequence of TDC processing of the distance measuring device according to the first embodiment.

FIG. 5 is a diagram illustrating an example of histogram generation processing of the distance measuring device according to the first embodiment.

FIG. 6 is a block diagram illustrating a configuration example of a light detection unit according to a second embodiment.

FIG. 7 is a diagram illustrating an example of a sequence of TDC processing of a distance measuring device according to the second embodiment.

FIG. 8 is a diagram illustrating an example of a sequence of TDC processing of a distance measuring device according to a third embodiment.

FIG. 9 is a diagram illustrating an example of a sequence of TDC processing of a distance measuring device according to a fourth embodiment.

FIG. 10 is a diagram illustrating an example of a sequence of TDC processing of a distance measuring device according to a fifth embodiment.

FIG. 11 is a diagram illustrating an example of a sequence of TDC processing of a distance measuring device according to a sixth embodiment.

FIG. 12 is a diagram illustrating an example of distance measuring modes of a distance measuring device according to a seventh embodiment.

FIG. 13 is a diagram illustrating an example of distance measuring modes of a distance measuring device according to an eighth embodiment.

FIG. 14 is a perspective view illustrating a stacking example of a light detection unit according to a ninth embodiment.

FIG. 15 is a perspective view illustrating a stacking example of a light detection unit according to a tenth embodiment.

FIG. 16 is a block diagram illustrating a schematic configuration example of a vehicle control system.

FIG. 17 is an explanatory diagram illustrating an example of an installation position of an imaging section.

### MODE FOR CARRYING OUT THE INVENTION

Modes for carrying out the present technology (hereinafter referred to as embodiments) will be described hereinafter. The description will be given in the following order.
1. First embodiment (an example in which three subframes are provided in a time-division manner in a frame, mutually different first TDC code circulation periods are set in two subframes, and a second TDC code circulation period longer than the first TDC code circulation period is provided in the remaining one subframe)
2. Second embodiment (an example in which two subframes and two subframes are provided in parallel in a frame, mutually different first TDC code circulation periods are set to two subframes, and a second TDC code circulation period longer than the first TDC code circulation period is provided in the remaining parallel subframes)
3. Third embodiment (an example in which four subframes are provided in a time-division manner in a frame, mutually different first TDC code circulation periods are set in three subframes, and a second TDC code circulation period longer than the first TDC code circulation period is provided in the remaining one subframe)
4. Fourth embodiment (an example in which four subframes are provided in a frame in a time-division manner, mutually different first TDC code circulation periods are set in three subframes, and a second TDC code circulation period longer than the first TDC code circulation period is provided in the remaining one subframe, so as to expand a distance measurement range)
5. Fifth embodiment (an example in which three subframes and three subframes are provided in parallel in a frame, mutually different first TDC code circulation periods are set to three subframes, and a second TDC code circulation period longer than the first TDC code circulation period is provided in remaining parallel subframes, so as to expand a distance measurement range)
6. Sixth embodiment (an example in which two subframes and two subframes are provided in parallel in a frame, two first TDC code circulation periods among three mutually different first TDC code circulation periods are set to two subframes, and a second TDC code circulation period longer than the first TDC code circulation period and the remaining one first TDC code circulation period are provided in the remaining parallel subframes, so as to expand a distance measurement range)
7. Seventh embodiment (an example of distance measuring modes in distance measurement in which a plurality of subframes is provided in a frame in a time-division manner)
8. Eighth embodiment (an example of distance measuring modes in distance measurement in which a plurality of subframes is provided in parallel in a frame)
9. Ninth embodiment (an example in which a pixel array section is provided on an upper layer chip and a circuit array section is provided on a lower layer chip)
10. Tenth embodiment (an example in which an upper layer chip is provided with a pixel array section in which pixels each provided with a plurality of SPADs are arranged, and a lower layer chip is provided with a circuit array section)
11. Example of application to mobile object

### 1. First Embodiment

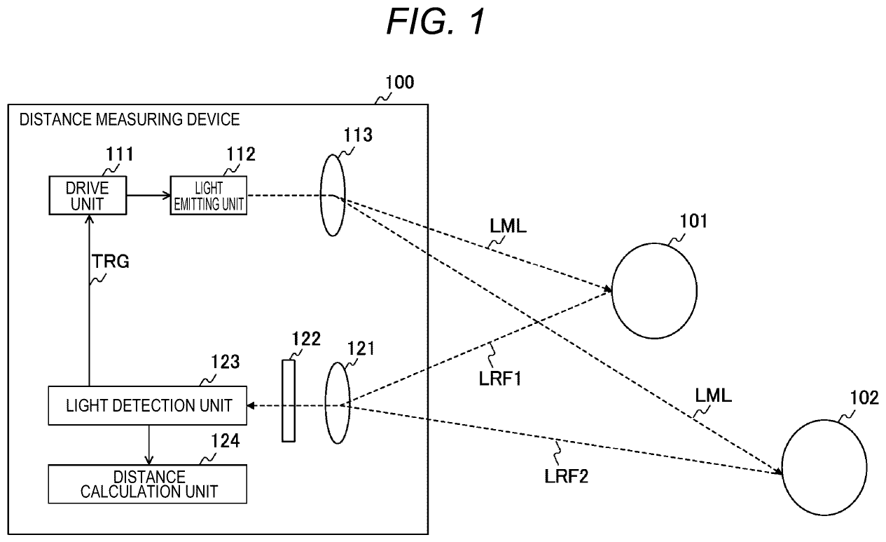

FIG. 1 is a block diagram illustrating a configuration example of a distance measuring device according to a first embodiment.

In the figure, a distance measuring device 100 performs distance measurement on the basis of ToF, for example. Here, the distance measuring device 100 emits distance measurement light LML including photons to each of objects 101 and 102. Then, the distance measuring device 100 can calculate distances to the individual objects 101 and 102 on the basis of light reception timings of reflected light LRF1 and reflected light LRF2 of the distance measurement light LML reflected by the respective objects 101 and 102.

At this time, the distance measuring device 100 can calculate distances to the individual objects 101 and 102 from histograms generated on the basis of count values counted with different TDC resolutions. Here, the distance measuring device 100 can generate two or more first histograms having mutually different TDC code circulation periods in a first distance measuring period, and can generate a second histogram having a TDC resolution coarser than that of the first histogram, in a second distance measuring period. As a result, the distance measuring device 100 can expand a distance measurement range while restraining an increase in load applied to generation of the histogram, and can identify a correspondence between the individual objects 101 and 102 and a plurality of peaks of the histogram caused by a multipath.

The distance measuring device 100 includes a drive unit 111, a light emitting unit 112, a light detection unit 123, a distance calculation unit 124, optical systems 113 and 121, and an optical filter 122.

The drive unit 111 drives the light emitting unit 112 in accordance with an instruction from the light detection unit 123. At this time, the drive unit 111 sets a drive timing of the light emitting unit 112 in accordance with a light emission trigger TRG from the light detection unit 123.

The light emitting unit 112 emits light of a predetermined wavelength region in accordance with the driving of the drive unit 111. The predetermined wavelength range may be a visible range or an infrared range. The light emitting unit 112 can change a light emission interval of the distance measurement light LML. A laser diode can be used as the light emitting unit 112. The light emitting unit 112 may change a light emitting region. At this time, a plurality of laser diodes may be provided.

The optical system 113 forms the distance measurement light LML as an image on the objects 101 and 102. Note that the optical system 113 may include a lens, an optical filter, and the like.

The optical system 121 forms each of the reflected light LRF1 and the reflected light LRF2 as an image on a light receiving surface of the light detection unit 123. Note that the optical system 121 may include a lens, a diaphragm, and the like.

The optical filter 122 removes light of an unnecessary wavelength band from each of the reflected light LRF1 and the reflected light LRF2.

The light detection unit 123 receives the reflected light LRF1 and the reflected light LRF2 reflected respectively from the objects 101 and 102. The light detection unit 123 can be provided with a single photon avalanche diode (SPAD) in order to receive the reflected light LRF1 and the reflected light LRF2. The light detection unit 123 can generate a histogram for every pixel on the basis of a count value obtained by counting time from when the light emitting unit 112 emits the distance measurement light LML in accordance with the light emission trigger TRG to when the SPAD receives the light. The histogram can indicate a relationship between the number of reactions of the SPAD (also referred to as light reception frequency) and a distance to each of the objects 101 and 102. The distance to each of the objects 101 and 102 can be converted on the basis of a count value obtained by counting, with the TDC, time from when the light emitting unit 112 emits the distance measurement light LML to when the SPAD receives the light. Note that, in the following description, a count value counted by the TDC is referred to as a TDC code.

Here, the light detection unit 123 can count time in a time-division manner and generate a histogram in a time-division manner. At this time, the light detection unit 123 can set the first distance measuring period and the second distance measuring period in a time-division manner, and allocate a same circuit resource to time counting and histogram generation of the first distance measuring period and time counting and histogram generation of the second distance measuring period.

The distance calculation unit 124 can obtain distances to the individual objects 101 and 102 for every pixel, on the basis of peaks in the histograms generated by the light detection unit 123. At this time, the distance calculation unit 124 can calculate the distances to the individual objects 101 and 102 on the basis of a peak positions in the histogram. Here, the light detection unit 123 can generate histograms having mutually different TDC resolutions in TDC code circulation periods. Note that the TDC code circulation period is a period in which the TDC code reaches a maximum value from 0 at a certain TDC resolution. The TDC resolution is a time resolution based on the TDC code, and is synonymous with a bin width of the histogram. As a result, when a subrange is set in a shorter one of the TDC code circulation periods, a peak of the histogram based on reflection of light from the objects 101 and 102 at mutually different distances can be uniquely discriminated by specifying each subrange in which each peak exists. Therefore, even in a case where the distance measurement light LML is reflected by the objects 101 and 102 at mutually different distances, the distance calculation unit 124 can prevent that a distance of one of the objects 101 and 102 cannot be calculated or a distance of a non-existent object is calculated.

Here, a light emission interval of the distance measurement light LML in the first distance measuring period may be shorter than a light emission interval of the distance measurement light LML in the second distance measuring period. As a result, it is possible to set a light emission interval according to a bin width of the first histogram having a fine TDC resolution while relaxing a restriction of a light emission interval that is set according to a bin width of the second histogram having a coarse TDC resolution.

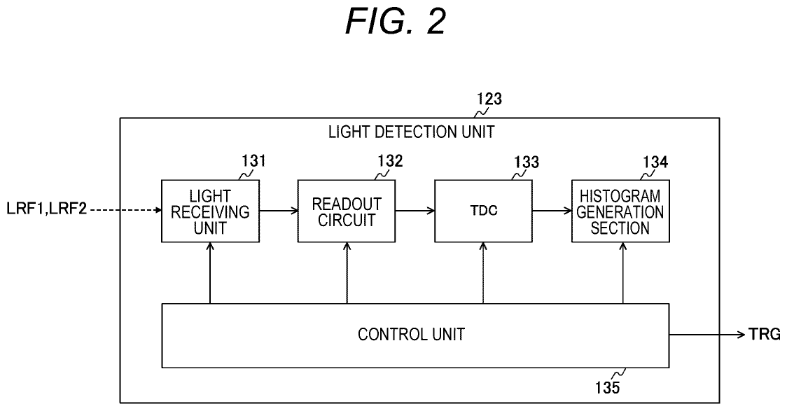

FIG. 2 is a block diagram illustrating a configuration example of the light detection unit according to the first embodiment.

In the figure, the light detection unit 123 includes a light receiving unit 131, a readout circuit 132, a TDC 133, a histogram generation section 134, and a control unit 135.

The light receiving unit 131 is provided with a plurality of pixels. The pixels are arranged in a matrix in a row direction and a column direction. Each pixel can be provided with a SPAD. Each pixel may include a single SPAD or a plurality of SPADs.

The readout circuit 132 reads pixel data from each pixel of a pixel array section 140, and outputs the pixel data to the TDC 133.

The TDC 133 measures a time difference from light emission to light reception, and converts the value into a digital value. At this time, the digital value can indicate a time difference between an output timing of the light emission trigger TRG and an output timing of a SPAD pulse. Furthermore, the TDC 133 may be a multi-hit TDC that measures a time of a light reception timing of each of the reflected light LRF1 and the reflected light LRF2 having mutually different light emission intervals of the distance measurement light LML. At this time, the TDC 133 can obtain a time difference of each of a plurality of SPAD pulses sequentially detected after the output of the light emission trigger TRG.

The histogram generation section 134 can generate a histogram indicating a relationship between a time difference from light emission to light reception and the number of reactions of the light emitting unit 112. At this time, the histogram generation section 134 can generate histograms having mutually different TDC resolutions in mutually different TDC code circulation periods. For example, the histogram generation section 134 can generate two or more first histograms having mutually different TDC code circulation periods in a first distance measuring period, and generate a second histogram having a TDC resolution coarser than that of the first histogram, in a second distance measuring period. At this time, the histogram generation section 134 can make the TDC resolutions of the two or more first histograms equal to each other. The number of distances to the object that can be calculated by the distance calculation unit 124 is equal to or smaller than the number of first histograms.

The control unit 135 controls the light receiving unit 131, the readout circuit 132, the TDC 133, and the histogram generation section 134. For example, the control unit 135 controls operation timings of the light receiving unit 1311, the readout circuit 132, the TDC 133, and the histogram generation section 134 so as to generate a histogram corresponding to the TDC code circulation period that is set for every subframe obtained by dividing the frame. Furthermore, the control unit 135 outputs the light emission trigger TRG to the drive unit 111. At this time, the control unit 135 may output the light emission trigger TRG to the drive unit 111 so that a light emission interval of the distance measurement light LML in the first distance measuring period becomes shorter than a light emission interval of the distance measurement light LML in the second distance measuring period.

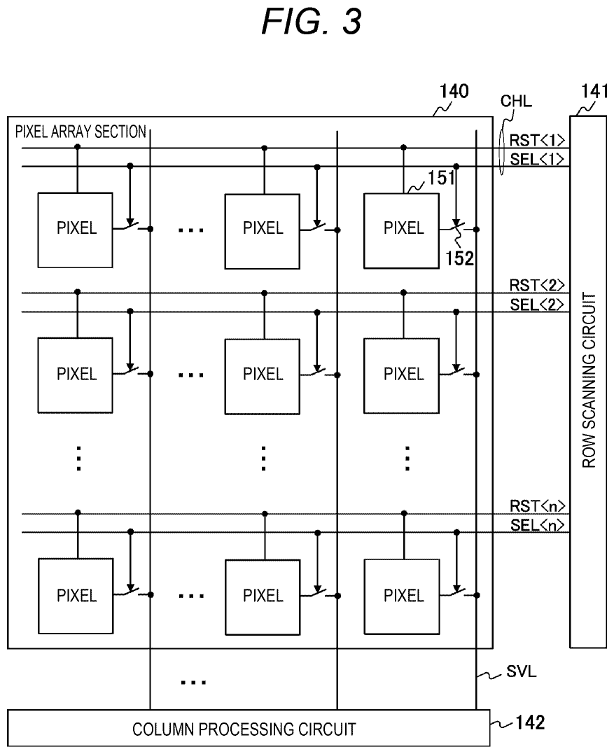

FIG. 3 is a block diagram illustrating a configuration example of a solid-state light receiving unit to which the photodetection device according to the first embodiment is applied.

In the figure, the light receiving unit 131 and the readout circuit 132 include the pixel array section 140, a row scanning circuit 141, and a column processing circuit 142. These circuits may be disposed on a single semiconductor substrate or may be disposed on a multilayer substrate.

The pixel array section 140 includes pixels 151 arranged in a matrix in a row direction and a column direction. Each pixel 151 is connected to a signal line SVL via a switch 152 for every column, and is connected to a horizontal control line chl for every row. each pixel 151 outputs a count value of pulses generated in response to incidence of photons as pixel data.

The row scanning circuit 141 sequentially selects a row in synchronization with the vertical synchronization signal. At this time, the row scanning circuit 141 can select the pixel 151 via the horizontal control line CHL. The row scanning circuit 141 supplies a selection signal SEL<1>-<n> to the switches 152 for every row to select the pixels 151 for every row. Furthermore, the row scanning circuit 141 supplies a count reset signal RST<1>-<n> to the pixels 151 for every row to reset the count values of the individual pixels 151 for every row. The row scanning circuit 141 may include a vertical arbiter that arbitrates the selection of a row including the pixel 151 where photons have been detected.

The column processing circuit 142 performs various types of signal processing on the pixel data transmitted via the signal line SVL. The column processing circuit 142 may include a line scanner that scans columns. The column processing circuit 142 may include a horizontal arbiter that arbitrates the selection of a column including a pixel 151 where photons have been detected.

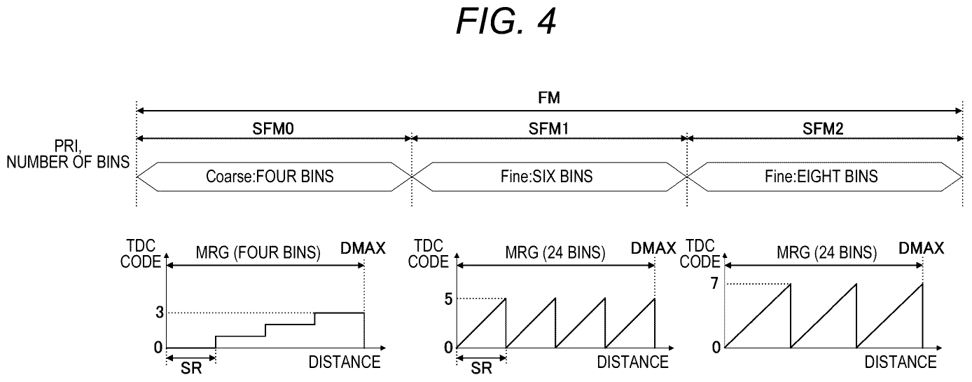

FIG. 4 is a diagram illustrating an example of a sequence of TDC processing of the distance measuring device according to the first embodiment.

In the figure, a frame FM is divided into three subframes SFM0 to SFM2. The subframes SFM1 and SFM2 are allocated to the first distance measuring period, and the subframe SFM0 is allocated to the second distance measuring period. A plurality of subframes SFM1 and SFM2 having mutually different TDC code circulation periods is allocated to the first distance measuring period. In each of the subframes SFM1 and SFM2, a TDC code is circulated a plurality of times.

At this time, the TDC code circulation period of the subframe SFM1 can be made shorter than the TDC code circulation period of the subframe SFM2. The TDC code circulation period of the subframe SFM0 can be set to a period corresponding to a distance measurement range MRG. A bin width that is a TDC resolution of a histogram in the second distance measuring period can be made equal to or smaller than a TDC code circulation period of the first distance measuring period. For example, a bin width of a histogram generated in the subframe SFM0 may be equal to the TDC code circulation period of the subframe SFM1. Furthermore, TDC resolutions of the two or more first histograms generated in the first distance measuring period can be made equal to each other. For example, bin widths of histograms generated in the subframes SFM1 and SFM2 may be made equal to each other. Here, a histogram generated in each of the subframes SFM1 and SFM2 in the first distance measuring period is referred to as a Fine histogram, and a histogram generated in the subframe SFM0 in the second distance measuring period is referred to as a Coarse histogram. Furthermore, a distance corresponding to a light time-of-flight corresponding to all the bins of the Fine histogram having the smallest number of bins is set as a subrange SR. At this time, a bin width of the Coarse histogram can be set to the subrange SR. Furthermore, the distance measurement range MRG can be given by a distance corresponding to a least common multiple of the number of bins of two Fine histograms generated in the individual subframes SFM1 and SFM2. At this time, a maximum number of objects whose distance can be measured per distance measurement point is two.

Here, an upper limit of the bin width that is a TDC resolution of the histogram in the second distance measuring period may be a minimum value of the TDC code circulation period of the first distance measuring period. Furthermore, a lower limit of the bin width that is a TDC resolution of the histogram in the second distance measuring period may be a value obtained by dividing the distance measurement range by a maximum value of the number of bins of the Coarse histogram.

For example, the bin width of the Coarse histogram can be set so as to satisfy a condition that the bin width of the Coarse histogram is equal to or smaller than a distance corresponding to a shorter one of the TDC code circulation periods. As a result, it is possible to identify a correspondence between a plurality of peaks of the histogram caused by a multipath and the plurality of objects 101 and 102.

Furthermore, the bin width of the Coarse histogram can be set so as to satisfy a condition that the bin width of the Coarse histogram is equal to or larger than a value obtained by dividing the distance measurement range by a maximum value of the number of histogram bins. As a result, it is possible to expand the distance measurement range MRG while restraining an increase in load applied to generation of the histogram.

For example, the number of bins of the Coarse histogram generated in the subframe SFM0 can be set to four, the number of bins of the Fine histogram generated in the subframe SFM1 can be set to six, and the number of bins of the Fine histogram generated in the subframe SFM2 can be set to eight. Here, a TDC code circulation period of the Fine histogram generated in the subframe SFM1 can be set to the subrange SR, and the bin width of the Coarse histogram generated in the subframe SFM0 can be set to the subrange SR. At this time, a bin width of the Fine histogram generated in each of the subframes SFM1 and SFM2 can be set to SR/6. Furthermore, the number of TDC code circulations in the subframe SFM0 can be set to one, the number of TDC code circulations in the subframe SFM1 can be set to four, and the number of TDC code circulations in the subframe SFM2 can be set to three.

Furthermore, the distance measurement range MRG can be given by a distance corresponding to a least common multiple=24 of the number of bins=6 of two Fine histograms generated in the subframe SFM1 and the number of bins=8 of two Fine histograms generated in the subframe SFM2.

Furthermore, a light emission interval of the distance measurement light LML in the first distance measuring period can be made shorter than a light emission interval of the distance measurement light LML in the second distance measuring period. Furthermore, light emission intervals of the distance measurement light LML of the individual subframes SFM1 and SFM2 in the first distance measuring period may be integral multiples of TDC code circulation periods of the respective subframes SFM1 and SFM2 in the first distance measuring period. At this time, the numbers of times of emission of the distance measurement light LML in the individual subframes SFM1 and SFM2 in the first distance measuring period can be set to values obtained by dividing the distance measurement range MRG by the numbers of bins of respective subframes SFM1 and SFM2. For example, the number of times of emission of the distance measurement light LML in the subframe SFM0 is set to one. At this time, the number of times of emission of the distance measurement light LML in the subframe SFM1 can be set to four, and the number of times of emission of the distance measurement light LML in the subframe SFM2 can be set to three.

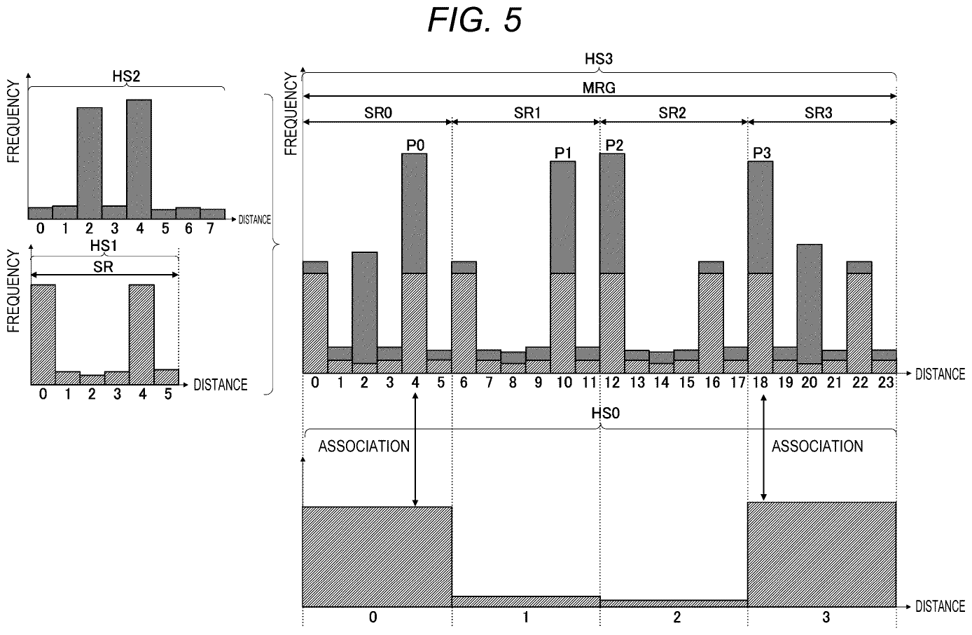

FIG. 5 is a diagram illustrating an example of histogram generation processing of the distance measuring device according to the first embodiment.

In the figure, the histogram generation section 134 generates a Coarse histogram HS0 for every TDC code circulation period of the subframe SFM0. Furthermore, the histogram generation section 134 generates a Fine histogram HS1 for every TDC code circulation period of the subframe SFM1. Furthermore, the histogram generation section 134 generates a Fine histogram HS2 for every TDC code circulation period of the subframe SFM2. At this time, assuming that the two objects 101 and 102 at mutually different distances are in the distance measurement range MRG, two peaks occur in the Coarse histogram HS0 and the individual Fine histograms HS1 and HS2.

The distance calculation unit 124 arranges the Fine histogram HS1 by an amount of the distance measurement range MRG, for every TDC code circulation period of the subframe SFM1. Furthermore, the distance calculation unit 124 arranges the Fine histogram HS2 by an amount of the distance measurement range MRG, for every TDC code circulation period of the subframe SFM2. Then, a tiling histogram HS3 is generated in which the Fine histograms HS1 and HS2 arranged by an amount of the distance measurement range MRG are superimposed for every bin.

At this time, since a bin width of the Coarse histogram HS0 is set to the subrange SR, two peaks of the Coarse histogram HS0 each include two peaks of the Fine histogram HS1. Since the TDC code circulation period of the Fine histogram HS1 is shorter than the TDC code circulation period of the Fine histogram HS2, in each subrange SR of two peaks of HS0, two peaks of the Fine histogram HS1 and two peaks of the Fine histogram HS2 do not overlap at a bin position of the two peaks of HS0.

Therefore, by associating a bin position where peaks of the two Fine histograms HS1 and HS2 in each subrange SR overlap with each other with a bin position of a peak of the Coarse histogram HS0, distances to up to two objects 101 and 102 per distance measurement point can be calculated.

For example, in the subframe SFM1, the number of TDC code circulations is set to four, and four TDC code circulation periods are provided. At this time, subranges SRO to SR3 are set in the individual TDC code circulation periods of the subframe SFM1. By disposing the Fine histogram of each TDC code circulation period of the subframe SFM1 for each of the subranges SRO to SR3, a position of 24 bins of the Fine histogram are converted into a distance.

Here, for example, it is assumed that a distance to the object 101 corresponds to a position of four bins of the distance measurement range MRG, and a distance to the object 102 corresponds to a position of 18 bins of the distance measurement range MRG. At this time, in each of the subranges SRO to SR3 of the tiling histogram HS3, peaks PO to P3 in which the peaks of the two Fine histograms HS1 and HS2 overlap each other occur.

Here, in the subrange SRO, the peak PO occurs in which the peaks of the two Fine histograms HS1 and HS2 overlap with each other at a position of four bins, and the peak of the Coarse histogram HS0 occurs. Furthermore, in the subrange SR3, the peak P3 occurs in which the peaks of the two Fine histograms HS1 and HS2 overlap with each other at a position of 18 bins, and the peak of the Coarse histogram HS0 occurs. Therefore, a distance to the object 101 can be calculated by associating a position of four bins of the peak PO where the peaks of the two Fine histograms HS1 and HS2 of the subrange SRO overlap with each other with a position of zero bins of the peak of the Coarse histogram HS0. Furthermore, a distance to the object 102 can be calculated by associating a position of 18 bins of the peak P3 where the peaks of the two Fine histograms HS1 and HS2 of the subrange SR3 overlap with each other with a position of three bins of the peak of the Coarse histogram HS0.

Whereas, in the subrange SR1, the peak Pl occurs in which the peaks of the two Fine histograms HS1 and HS2 overlap with each other at a position of 10 bins, and a peak of the Coarse histogram HSO does not occur. Furthermore, in the subrange SR2, the peak P2 occurs in which the peaks of the two Fine histograms HS1 and HS2 overlap with each other at a position of 12 bins, and a peak of the Coarse histogram HSO does not occur. Therefore, the peaks P1 and P2 of the tiling histogram HS3 can be determined as false peaks.

As described above, in the first embodiment, histograms having mutually different TDC resolutions are generated in mutually different TDC code circulation periods. At this time, the subrange SR is set in a shorter one of the TDC code circulation periods. As a result, peaks of the histogram based on reflection of light from the objects 101 and 102 at mutually different distances can be uniquely determined by specifying each subrange in which each peak exists. For this reason, even in a case where the objects 101 and 102 at mutually different distances are in the distance measurement range MRG, it is possible to prevent that a distance of one of the objects 101 and 102 cannot be calculated or a distance of a non-existent object is calculated.

Furthermore, the Coarse histogram HS0 having a TDC resolution coarser than that of the Fine histograms HS1 and HS2 is generated together with two or more Fine histograms HS1 and HS2 having mutually different TDC code circulation periods. As a result, it is possible to specify the false peaks P1 and P2 while specifying the true peaks PO and P3 of the tiling histogram HS3, and it is possible to improve the distance measurement accuracy of the objects 101 and 102 while restraining an increase in load applied to generation of the histogram.

### 2. Second Embodiment

In the first embodiment described above, the three subframes SFM0 to SFM2 are provided in the frame FM in a time-division manner, and the mutually different first TDC code circulation periods are set in the two subframes SFM1 and SFM2. Then, the second TDC code circulation period longer than the first TDC code circulation period is provided in the remaining one subframe SFM0. In this second embodiment, two subframes SFM1 and SFM2 and two subframes SFM1 and SFM2 are provided in parallel in a frame FM, and mutually different first TDC code circulation periods are set for the two subframes SFM1 and SFM2. Then, a second TDC code circulation period longer than the first TDC code circulation period is provided in the remaining parallel subframes SFM1 and SFM2.

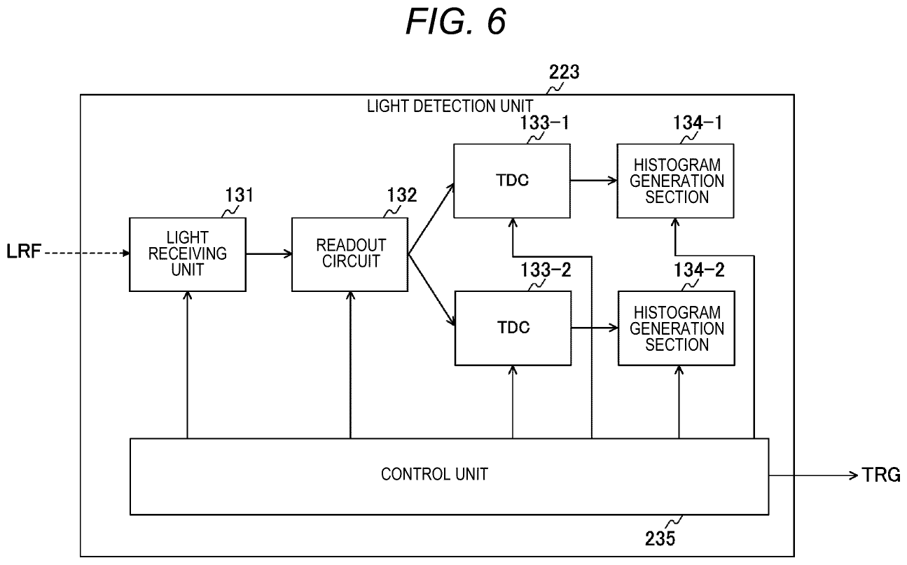

FIG. 6 is a block diagram illustrating a configuration example of a light detection unit according to the second embodiment.

In the figure, a light detection unit 223 includes TDCs 133-1 and 133-2, histogram generation sections 134-1 and 134-2, and a control unit 235, instead of the TDC 133, the histogram generation section 134, and the control unit 135 of the first embodiment described above. Other configurations of the light detection unit 223 of the second embodiment are similar to those of the light detection unit 123 of the first embodiment described above.

The light detection unit 223 receives reflected light LRF1 and reflected light LRF2 reflected respectively from objects 101 and 102. The light detection unit 223 can generate a histogram for every pixel on the basis of a count value obtained by counting time from when a light emitting unit 112 emits distance measurement light LML in accordance with a light emission trigger TRG to when a SPAD receives the light.

Here, the light detection unit 223 can count time in parallel, and generate a histogram in parallel. At this time, the light detection unit 223 can set the first distance measuring period and the second distance measuring period in parallel, and allocate separate circuit resources to time counting and histogram generation of the first distance measuring period and time counting and histogram generation of the second distance measuring period.

Each of the TDCs 133-1 and 133-2 measures a time difference from light emission to light reception, and converts the value to a digital value. At this time, each of the TDCs 133-1 and 133-2 may count time on the basis of mutually different TDC code circulation periods. For example, the TDC 133-1 can count time on the basis of a TDC code circulation period that is set in the first distance measuring period. The TDC 133-2 can count time on the basis of a TDC code circulation period that is set in the second distance measuring period.

Each of the histogram generation sections 134-1 and 134-2 can generate a histogram indicating a relationship between a time difference from light emission to light reception and the number of reactions of the light emitting unit 112. At this time, the individual histogram generation sections 134-1 and 134-2 can generate histograms having mutually different TDC resolutions in mutually different TDC code circulation periods. For example, the histogram generation section 134-1 can generate two or more Fine histograms having mutually different TDC code circulation periods in the first distance measuring period. The histogram generation section 134-2 can generate a Coarse histogram having a TDC resolution coarser than that of the Fine histogram in the second distance measuring period.

The control unit 235 controls a light receiving unit 131, a readout circuit 132, the TDCs 133-1 and 133-2, and the histogram generation sections 134-1 and 134-2. For example, the control unit 235 controls an operation timing of each of the TDCs 133-1 and 133-2 and each of the histogram generation sections 134-1 and 134-2 such that time counting and histogram generation in the first distance measuring period and time counting and histogram generation in the second distance measuring period are performed in parallel.

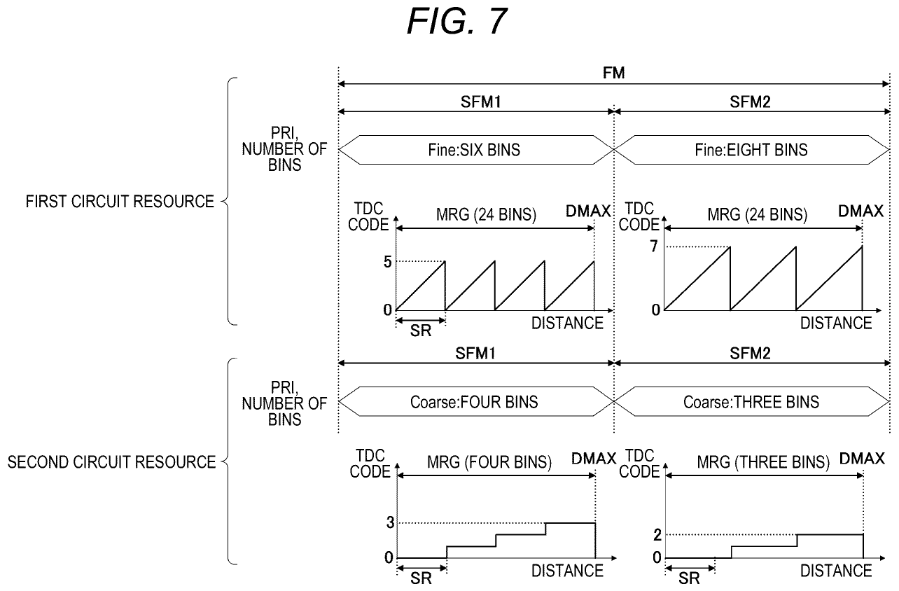

FIG. 7 is a diagram illustrating an example of a sequence of TDC processing of a distance measuring device according to the second embodiment.

In the figure, the frame FM is divided into the two subframes SFM1 and SFM2. The first distance measuring period and the second distance measuring period are set in parallel, and the subframes SFM1 and SFM2 are allocated to each of the first distance measuring period and the second distance measuring period. A first circuit resource is allocated to the first distance measuring period, and a second circuit resource is allocated to the second distance measuring period. The TDC 133-1 and the histogram generation section 134-1 can be allocated to the first circuit resource, and the TDC 133-2 and the histogram generation section 134-2 can be allocated to the second circuit resource.

At this time, in the first distance measuring period, the TDC code circulation period of the subframe SFM1 can be made shorter than the TDC code circulation period of the subframe SFM2. In the second distance measuring period, the TDC code circulation period of the subframe SFM1 can be set to a period corresponding to a distance measurement range MRG. A bin width that is a TDC resolution of a histogram of the second distance measuring period can be made equal to or smaller than a TDC code circulation period of the first distance measuring period. For example, a bin width of a histogram generated in the subframe SFM1 of the second distance measuring period can be made equal to the TDC code circulation period of the subframe SFM1 of the first distance measuring period. Furthermore, TDC resolutions of the two or more Fine histograms generated in the first distance measuring period can be made equal to each other. For example, bin widths of the Fine histograms generated in the subframes SFM1 and SFM2 in the first distance measuring period can be made equal to each other. Furthermore, the distance measurement range MRG can be given by a distance corresponding to a least common multiple of the number of bins of two Fine histograms generated in the individual subframes SFM1 and SFM2 in the first distance measuring period. At this time, a maximum number of objects whose distance can be measured per distance measurement point is two.

Here, the bin width of the Coarse histogram can be set so as to satisfy a condition that the bin width of the Coarse histogram is equal to or smaller than a distance corresponding to a shorter one of the TDC code circulation periods. Furthermore, the bin width of the Coarse histogram can be set so as to satisfy a condition that the bin width of the Coarse histogram is equal to or larger than a value obtained by dividing the distance measurement range by a maximum value of the number of histogram bins.

For example, in the first distance measuring period, the number of bins of the Fine histogram generated in the subframe SFM1 can be set to six, and the number of bins of the Fine histogram generated in the subframe SFM2 can be set to eight. In the second distance measuring period, the number of bins of the Coarse histogram generated in the subframe SFM1 can be set to four, and the number of bins of the Coarse histogram generated in the subframe SFM2 can be set to three. Here, a TDC code circulation period of the Fine histogram generated in the subframe SFM1 of the first distance measuring period can be set to a subrange SR, and the bin width of the Coarse histogram generated in the subframe SFM1 of the second distance measuring period can be set to the subrange SR.

As described above, in the second embodiment described above, the two subframes SFM1 and SFM2 and the two subframes SFM1 and SFM2 are provided in parallel in the frame FM, and a set of the two subframes SFM1 and SFM2 is allocated to the first distance measuring period and the second distance measuring period. Then, the mutually different first TDC code circulation periods are set in the two subframes SFM1 and SFM2 of the first distance measuring period. Furthermore, the second TDC code circulation period longer than the first TDC code circulation period is provided in the subframes SFM1 and SFM2 of the second distance measuring period. This configuration eliminates the need to provide the three subframes SFM0 to SFM2 in the frame FM in order to generate the two Fine histograms HS1 and HS2 and one Coarse histogram HS0. Therefore, while restraining an increase in load, it is possible to improve the distance measurement accuracy of the objects 101 and 102 and to improve a frame rate applied to generation of the histogram.

Note that, in the second embodiment described above, in order to perform distance measurement of the two objects 101 and 102, it is sufficient that there are two Fine histograms generated in the individual subframes SFM1 and SFM2 in the first distance measuring period and one Coarse histogram generated in the subframe SFM1 in the second distance measuring period. Therefore, one Coarse histogram generated in the subframe SFM2 of the second distance measuring period is unnecessary.

### 3. Third Embodiment

In the first embodiment described above, the three subframes SFM0 to SFM2 are provided in the frame FM in a time-division manner, and the mutually different first TDC code circulation periods are set in the two subframes SFM1 and SFM2. Then, the second TDC code circulation period longer than the first TDC code circulation period is provided in the remaining one subframe SFM0. In this third embodiment, four subframes are provided in a frame FM in a time-division manner, and mutually different first TDC code circulation periods are set to three subframes. Then, a second TDC code circulation period longer than the first TDC code circulation period is provided in the remaining one subframe.

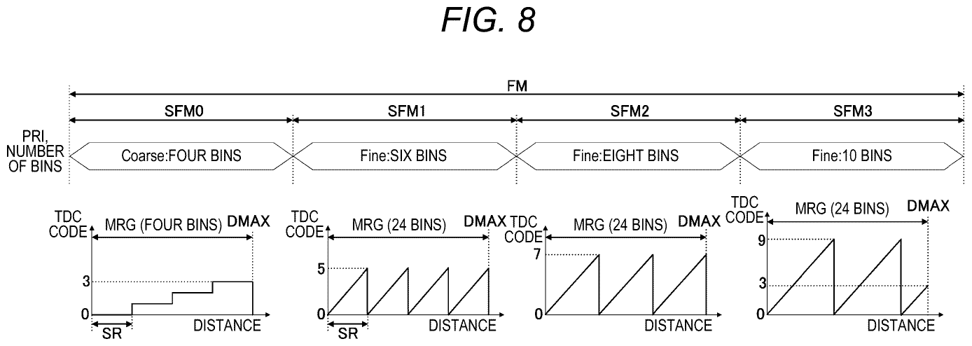

FIG. 8 is a diagram illustrating an example of a sequence of TDC processing of a distance measuring device according to the third embodiment.

In the figure, the frame FM is divided into four subframes SFM0 to SFM3. The subframes SFM1 to SFM3 are allocated to a first distance measuring period, and the subframe SFM0 is allocated to a second distance measuring period. A plurality of subframes SFM1 to SFM3 having mutually different TDC code circulation periods is allocated to the first distance measuring period. In each of the subframes SFM1 to SFM3, a TDC code is circulated a plurality of times.

At this time, the TDC code circulation period of the subframe SFM1 can be made shorter than the TDC code circulation period of the subframe SFM2. The TDC code circulation period of the subframe SFM2 can be made shorter than the TDC code circulation period of the subframe SFM3. The TDC code circulation period of the subframe SFM0 can be set to a period corresponding to a distance measurement range MRG. A bin width that is a TDC resolution of a histogram of the second distance measuring period can be made equal to or smaller than a TDC code circulation period of the first distance measuring period. For example, a bin width of a histogram generated in the subframe SFM0 may be equal to the TDC code circulation period of the subframe SFM1. Furthermore, TDC resolutions of two or more Fine histograms generated in the first distance measuring period can be made equal to each other. For example, bin widths of Fine histograms generated in the subframes SFM1 to SFM3 can be made equal to each other. Here, a histogram generated in each of the subframes SFM1 to SFM3 in the first distance measuring period is referred to as a Fine histogram, and a histogram generated in the subframe SFM0 in the second distance measuring period is referred to as a Coarse histogram. Furthermore, a distance corresponding to a light time-of-flight corresponding to all the bins of the Fine histogram having the smallest number of bins is set as a subrange SR. At this time, a bin width of the Coarse histogram can be set to the subrange SR. Furthermore, the distance measurement range MRG can be given by a distance corresponding to a minimum value of a least common multiple of the number of bins of two Fine histograms generated from each set of two subframes among the three subframes SFM1 to SFM3. At this time, a maximum number of objects whose distance can be measured per distance measurement point is three.

Here, the bin width of the Coarse histogram can be set so as to satisfy a condition that the bin width of the Coarse histogram is equal to or smaller than a distance corresponding to a minimum TDC code circulation period of the Fine histogram. Furthermore, the bin width of the Coarse histogram can be set so as to satisfy a condition that the bin width of the Coarse histogram is equal to or larger than a value obtained by dividing the distance measurement range by a maximum value of the number of histogram bins.

For example, the number of bins of the Coarse histogram generated in the subframe SFM0 may be set to four. Furthermore, the number of bins of the Fine histogram generated in the subframe SFM1 can be set to six, the number of bins of the Fine histogram generated in the subframe SFM2 can be set to eight, and the number of bins of the Fine histogram generated in the subframe SFM3 can be set to 10. Here, a TDC code circulation period of the Fine histogram generated in the subframe SFM1 can be set to the subrange SR, and the bin width of the Coarse histogram generated in the subframe SFM0 can be set to the subrange SR. At this time, a least common multiple 1 cm (6, 8) of the number of bins of two Fine histograms generated from the subframes SFM1 and SFM2 is 24 bins. The least common multiple 1 cm (6, 10) of the number of bins of two Fine histograms generated from the subframes SFM1 and SFM3 is 30 bins. The least common multiple 1 cm (8, 10) of the number of bins of two Fine histograms generated from the subframes SFM2 and SFM3 is 40 bins. Therefore, the distance measurement range MRG is given by a minimum value=24 bins among the three least common multiples 1 cm (6, 8), 1 cm (6, 10), and 1 cm (8, 10).

Furthermore, a light emission interval of the distance measurement light LML in the first distance measuring period can be made shorter than a light emission interval of the distance measurement light LML in the second distance measuring period. Furthermore, light emission intervals of the distance measurement light LML of the individual subframes SFM1 to SFM3 in the first distance measuring period may be integral multiples of TDC code circulation periods of the respective subframes SFM1 to SFM3 in the first distance measuring period. At this time, the numbers of times of emission of the distance measurement light LML in the individual SFM1 to SFM3 in the first distance measuring period can be set to values obtained by dividing the distance measurement range MRG by the numbers of bins of respective subframes SFM1 to SFM3. For example, the number of times of emission of the distance measurement light LML in the subframe SFM0 is set to one. At this time, the number of times of emission of the distance measurement light LML in the subframe SFM1 can be set to four, the number of times of emission of the distance measurement light LML in the subframe SFM2 can be set to three, and the number of times of emission of the distance measurement light LML in the subframe SFM3 can be set to three.

As described above, in the third embodiment described above, the four subframes SFM0 to SFM3 are provided in the frame FM in a time-division manner, and the mutually different first TDC code circulation periods are set in the three subframes SFM1 to SFM3. Then, the second TDC code circulation period longer than the first TDC code circulation period is provided in the remaining one subframe SFM0. As a result, it is possible to expand the distance measurement range MRG while restraining an increase in load applied to generation of the histogram, and it is possible to achieve distance measurement of up to three objects per distance measurement point while restraining deterioration in distance measurement accuracy.

### 4. Fourth Embodiment

In the third embodiment described above, the four subframes SFM0 to SFM3 are provided in the frame FM in a time-division manner, and the mutually different first TDC code circulation periods are set in the three subframes SFM1 to SFM3. Then, the second TDC code circulation period longer than the first TDC code circulation period is provided in the remaining one subframe SFM0. In this fourth embodiment, four subframes SFM0 to SFM3 are provided in a frame FM in a time-division manner. Then, mutually different first TDC code circulation periods are set in the three subframes SFM1 to SFM3, and the second TDC code circulation period longer than the first TDC code circulation period is provided in the remaining one subframe SFM0, so as to enlarge the distance measurement range MRG. In the fourth embodiment, a maximum number of objects whose distance can be measured per distance measurement point is two, but a distance measurement range MRG is further expanded as compared with the third embodiment.

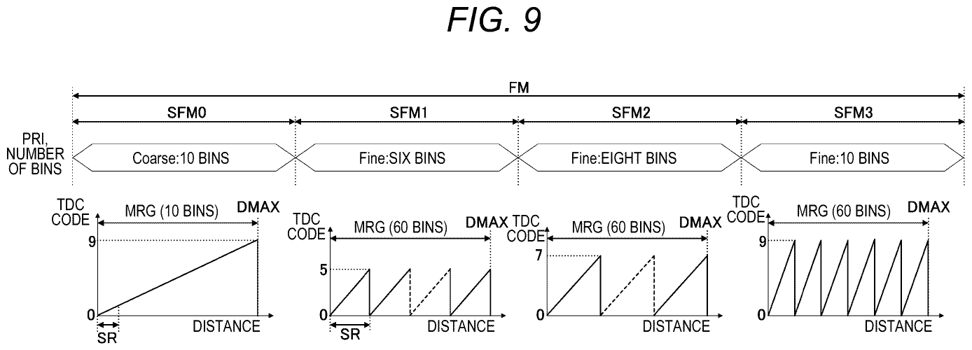

FIG. 9 is a diagram illustrating an example of a sequence of TDC processing of a distance measuring device according to the fourth embodiment.

In the figure, the frame FM is divided into the four subframes SFM0 to SFM3. The subframes SFM1 to SFM3 are allocated to a first distance measuring period, and the subframe SFM0 is allocated to a second distance measuring period. A plurality of subframes SFM1 to SFM3 having mutually different TDC code circulation periods is allocated to the first distance measuring period. In each of the subframes SFM1 to SFM, a TDC code is circulated a plurality of times.

At this time, the TDC code circulation period of the subframe SFM1 can be made shorter than the TDC code circulation period of the subframe SFM2. The TDC code circulation period of the subframe SFM2 can be made shorter than the TDC code circulation period of the subframe SFM3. The TDC code circulation period of the subframe SFM0 can be set to a period corresponding to the distance measurement range MRG. A bin width that is a TDC resolution of a histogram of the second distance measuring period can be made equal to or smaller than a TDC code circulation period of the first distance measuring period. For example, a bin width of a histogram generated in the subframe SFM0 may be equal to the TDC code circulation period of the subframe SFM1. Furthermore, TDC resolutions of two or more Fine histograms generated in the first distance measuring period can be made equal to each other. For example, bin widths of Fine histograms generated in the subframes SFM1 to SFM3 can be made equal to each other. Furthermore, the distance measurement range MRG can be given by a smaller value out of a least common multiple of the number of bins of the three Fine histograms generated from the three subframes SFM1 to SFM3 and a value obtained by multiplying the number of bins of a Coarse histogram by a minimum number of bins of the Fine histogram. At this time, a maximum number of objects that can be measured per distance measurement point is two.

Here, the bin width of the Coarse histogram can be set so as to satisfy a condition that the bin width of the Coarse histogram is equal to or smaller than a distance corresponding to a minimum TDC code circulation period of the Fine histogram. Furthermore, the bin width of the Coarse histogram can be set so as to satisfy a condition that the bin width of the Coarse histogram is equal to or larger than a value obtained by dividing the distance measurement range by a maximum value of the number of histogram bins.

The number of bins of the Fine histogram generated in the subframe SFM1 can be set to six, the number of bins of the Fine histogram generated in the subframe SFM2 can be set to eight, and the number of bins of the Fine histogram generated in the subframe SFM3 can be set to 10. Here, a TDC code circulation period of the Fine histogram generated in the subframe SFM1 can be set to a subrange SR, and the bin width of the Coarse histogram generated in the subframe SFM0 can be set to the subrange SR. At this time, the distance measurement range distance measurement range MRG is given by 120 bins, which is a least common multiple of the number of bins of the three Fine histograms generated from the three subframes SFM1 to SFM3. In this case, the number of bins of the Coarse histogram is set to 20 bins, and exceeds the maximum value of the number of bins of the Fine histogram, so that necessary circuit resources increase. From the viewpoint of circuit resources, a restriction may be provided so as to set the maximum value of the number of bins of the Fine histogram as the number of bins of the histogram that can be set. For example, the number of bins of the Coarse histogram generated in the subframe SFM0 is set to 10. At this time, the distance measurement range MRG is given by 60 bins, which is obtained by multiplying the number of bins of the Coarse histogram by a minimum number of bins of the Fine histogram, that is, 10 bins×6 bins.

Furthermore, a light emission interval of distance measurement light LML in the first distance measuring period can be made shorter than a light emission interval of the distance measurement light LML in the second distance measuring period. Furthermore, light emission intervals of the distance measurement light LML of the individual subframes SFM1 to SFM3 in the first distance measuring period may be integral multiples of TDC code circulation periods of the respective subframes SFM1 to SFM3 in the first distance measuring period. At this time, the numbers of times of emission of the distance measurement light LML in the individual SFM1 to SFM3 in the first distance measuring period can be set to values obtained by dividing the distance measurement range MRG by the numbers of bins of respective subframes SFM1 to SFM3. For example, the number of times of emission of the distance measurement light LML in the subframe SFM0 is set to one. At this time, the number of times of emission of the distance measurement light LML in the subframe SFM1 can be set to 10, the number of times of emission of the distance measurement light LML in the subframe SFM2 can be set to eight, and the number of times of emission of the distance measurement light LML in the subframe SFM3 can be set to six.

As described above, in the fourth embodiment described above, the four subframes SFM0 to SFM3 are provided in the frame FM in a time-division manner. Then, mutually different first TDC code circulation periods are set in the three subframes SFM1 to SFM3, and the second TDC code circulation period longer than the first TDC code circulation period is provided in the remaining one subframe SFM0, so as to enlarge the distance measurement range MRG. As a result, it is possible to expand the distance measurement range MRG while restraining an increase in load applied to generation of the histogram, and it is possible to achieve distance measurement of up to two objects per distance measurement point while restraining deterioration in distance measurement accuracy.

### 5. Fifth Embodiment

In the fourth embodiment described above, the four subframes SFM0 to SFM3 are provided in the frame FM in a time-division manner. Then, the mutually different first TDC code circulation periods are set in the three subframes SFM1 to SFM3, and the second TDC code circulation period longer than the first TDC code circulation period is provided in the remaining one subframe SFM0, so as to enlarge the distance measurement range MRG. In this fifth embodiment, three subframes SFM1 to SFM3 and three subframes SFM1 to SFM3 are provided in parallel in a frame FM, and each set of the three subframes SFM1 to SFM3 is allocated to a first distance measuring period and a second distance measuring period. Then, mutually different first TDC code circulation periods are set to the three subframes SFM1 to SFM3 of the first distance measuring period so as to enlarge a distance measurement range MRG. Furthermore, a second TDC code circulation period longer than the first TDC code circulation period is provided in the subframes SFM1 to SFM3 of the second distance measuring period.

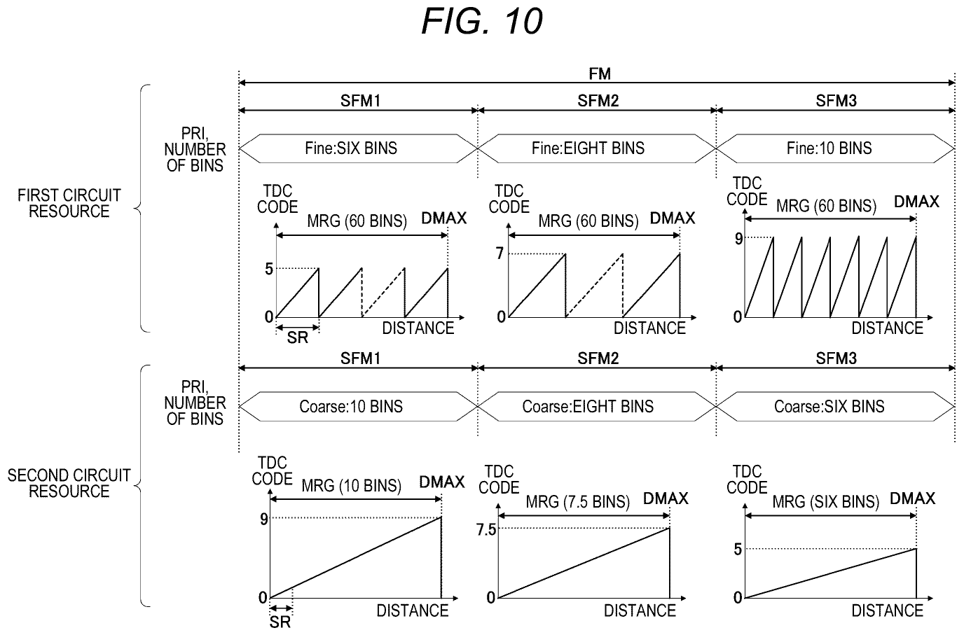

FIG. 10 is a diagram illustrating an example of a sequence of TDC processing of a distance measuring device according to the fifth embodiment.

In the figure, the frame FM is divided into the three subframes SFM1 to SFM3. The first distance measuring period and the second distance measuring period are set in parallel, and the subframes SFM1 to SFM3 are allocated to each of the first distance measuring period and the second distance measuring period. A first circuit resource is allocated to the first distance measuring period, and a second circuit resource is allocated to the second distance measuring period. A TDC 133-1 and a histogram generation section 134-1 can be allocated to the first circuit resource, and a TDC 133-2 and a histogram generation section 134-2 can be allocated to the second circuit resource.

At this time, in the first distance measuring period, the TDC code circulation period of the subframe SFM1 can be made shorter than the TDC code circulation period of the subframe SFM2. The TDC code circulation period of the subframe SFM2 can be made shorter than the TDC code circulation period of the subframe SFM3. In the second distance measuring period, the TDC code circulation period of the subframe SFM1 can be set to a period corresponding to the distance measurement range MRG. A bin width that is a TDC resolution of a histogram of the second distance measuring period can be made equal to or smaller than a TDC code circulation period of the first distance measuring period. For example, a bin width of a histogram generated in the subframe SFM1 of the second distance measuring period can be made equal to the TDC code circulation period of the subframe SFM1 of the first distance measuring period. Furthermore, TDC resolutions of two or more Fine histograms generated in the first distance measuring period can be made equal to each other. For example, bin widths of Fine histograms generated in the subframes SFM1 to SFM3 in the first distance measuring period can be made equal to each other. The distance measurement range MRG can be given by a smaller value out of a least common multiple of the number of bins of the three Fine histograms generated from the three subframes SFM1 to SFM3 and a value obtained by multiplying the number of bins of the Coarse histogram by a minimum number of bins of the Fine histogram. At this time, a maximum number of objects whose distance can be measured per distance measurement point is two.

Here, the bin width of the Coarse histogram can be set so as to satisfy a condition that the bin width of the Coarse histogram is equal to or smaller than a distance corresponding to a minimum TDC code circulation period of the Fine histogram. Furthermore, the bin width of the Coarse histogram can be set so as to satisfy a condition that the bin width of the Coarse histogram is equal to or larger than a value obtained by dividing the distance measurement range by a maximum value of the number of histogram bins.

For example, in the first distance measuring period, the number of bins of the Fine histogram generated in the subframe SFM1 can be set to six, the number of bins of the Fine histogram generated in the subframe SFM2 can be set to eight, and the number of bins of the Fine histogram generated in the subframe SFM3 can be set to 10. Furthermore, in the second distance measuring period, the number of bins of the Coarse histogram generated in the subframe SFM1 can be set to 10, the number of bins of the Coarse histogram generated in the subframe SFM2 can be set to eight, and the number of bins of the Coarse histogram generated in the subframe SFM3 can be set to six. Here, a TDC code circulation period of the Fine histogram generated in the subframe SFM1 of the first distance measuring period can be set to a subrange SR, and the bin width of the Coarse histogram generated in the subframe SFM1 of the second distance measuring period can be set to the subrange SR.

As described above, in this fifth embodiment described above, the three subframes SFM1 to SFM3 and the three subframes SFM1 to SFM3 are provided in parallel in the frame FM, and the set of three subframes SFM1 to SFM3 is allocated to the first distance measuring period and the second distance measuring period. Then, the mutually different first TDC code circulation periods are set to the three subframes SFM1 to SFM3 of the first distance measuring period so as to enlarge the distance measurement range MRG. Furthermore, the second TDC code circulation period longer than the first TDC code circulation period is provided in the subframes SFM1 to SFM3 of the second distance measuring period. As a result, while enabling distance measurement of objects 101 and 102, it is not necessary to provide the four subframes SFM0 to SFM3 in the frame FM in order to expand the distance measurement range MRG. Therefore, it is possible to improve the distance measurement accuracy of the objects 101 and 102 while restraining an increase in load applied to generation of the histogram, and it is possible to expand the distance measurement range MRG while improving a frame rate.

Note that, in the fifth embodiment described above, in order to perform distance measurement of the two objects 101 and 102, it is sufficient that there are the three Fine histograms generated in the individual subframes SFM1 to SFM3 in the first distance measuring period and one Coarse histogram generated in the subframe SFM1 in the second distance measuring period. Therefore, the two Coarse histograms generated in the subframes SFM2 and SFM3 in the second distance measuring period are unnecessary.

### 6. Sixth Embodiment

In the fifth embodiment described above, the mutually different first TDC code circulation periods are set to the three subframes SFM1 to SFM3 of the first distance measuring period so as to enlarge the distance measurement range MRG. Then, the second TDC code circulation period longer than the first TDC code circulation period is provided in the subframes SFM1 to SFM3 of the second distance measuring period. In this sixth embodiment, two subframes SFM1 and SFM2 and two subframes SFM1 and SFM2 are provided in parallel in a frame FM, and a set of the two subframes SFM1 and SFM2 is allocated to a first distance measuring period and a second distance measuring period. Then, two first TDC code circulation periods among three mutually different first TDC code circulation periods are set to the subframes SFM1 and SFM2 of the first distance measuring period so as to enlarge a distance measurement range MRG. Furthermore, a second TDC code circulation period longer than the first TDC code circulation period and the remaining one first TDC code circulation period are provided in the subframes SFM1 and SFM2 of the second distance measuring period.

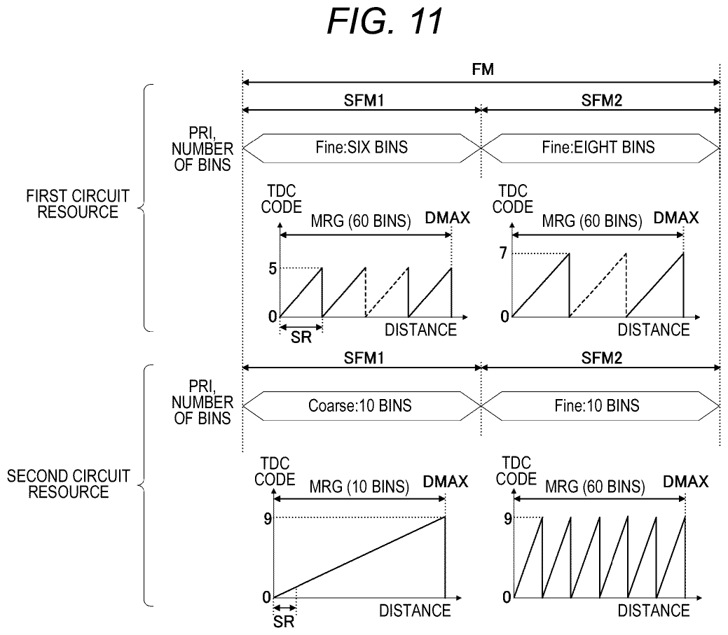

FIG. 11 is a diagram illustrating an example of a sequence of TDC processing of a distance measuring device according to the sixth embodiment.

In the figure, the frame FM is divided into the two subframes SFM1 and SFM2. The first distance measuring period and the second distance measuring period are set in parallel, and the subframes SFM1 and SFM2 are allocated to each of the first distance measuring period and the second distance measuring period. A first circuit resource is allocated to the first distance measuring period, and a second circuit resource is allocated to the second distance measuring period. A TDC 133-1 and a histogram generation section 134-1 can be allocated to the first circuit resource, and a TDC 133-2 and a histogram generation section 134-2 can be allocated to the second circuit resource.

At this time, in the first distance measuring period, the TDC code circulation period of the subframe SFM1 can be made shorter than the TDC code circulation period of the subframe SFM2. In the second distance measuring period, the TDC code circulation period of the subframe SFM2 can be made shorter than the TDC code circulation period of the subframe SFM1 in the first distance measuring period. The TDC code circulation period of the subframe SFM1 in the second distance measuring period can be set to a period corresponding to the distance measurement range MRG. A bin width that is a TDC resolution of a histogram of the subframe SFM1 in the second distance measuring period can be made equal to or smaller than a TDC code circulation period of the first distance measuring period. For example, a bin width of a histogram generated in the subframe SFM1 of the second distance measuring period can be made equal to the TDC code circulation period of the subframe SFM1 of the first distance measuring period. Furthermore, TDC resolutions of two or more Fine histograms generated in the first distance measuring period and a TDC decomposition of the Fine histogram generated in the subframe SFM2 in the second distance measuring period can be made equal to each other. For example, bin widths of Fine histograms generated in the subframes SFM1 and SFM2 in the first distance measuring period and the subframe SFM2 in the second distance measuring period can be made equal to each other. The distance measurement range MRG can be given by a smaller value out of a least common multiple of the number of bins of the three Fine histograms generated in the individual subframes SFM1 and SFM2 in the first distance measuring period and the subframe SFM2 in the second distance measuring period and a value obtained by multiplying the number of bins of a Coarse histogram by a minimum number of bins of the Fine histogram. At this time, a maximum number of objects that can be measured per distance measurement point is two.

Here, the bin width of the Coarse histogram can be set so as to satisfy a condition that the bin width of the Coarse histogram is equal to or smaller than a distance corresponding to a minimum TDC code circulation period of the Fine histogram. Furthermore, the bin width of the Coarse histogram can be set so as to satisfy a condition that the bin width of the Coarse histogram is equal to or larger than a value obtained by dividing the distance measurement range by a maximum value of the number of histogram bins.

For example, in the first distance measuring period, the number of bins of the Fine histogram generated in the subframe SFM1 can be set to six, and the number of bins of the Fine histogram generated in the subframe SFM2 can be set to eight. In the second distance measuring period, the number of bins of the Coarse histogram generated in the subframe SFM1 can be set to 10, and the number of bins of the Fine histogram generated in the subframe SFM2 can be set to 10. Here, a TDC code circulation period of the Fine histogram generated in the subframe SFM1 of the first distance measuring period can be set to a subrange SR, and the bin width of the Coarse histogram generated in the subframe SFM1 of the second distance measuring period can be set to the subrange SR.

As described above, in the sixth embodiment described above, the two subframes SFM1 and SFM2 and the two subframes SFM1 and SFM2 are provided in parallel in the frame FM. Then, two first TDC code circulation periods among the three mutually different first TDC code circulation periods are set to the two subframes SFM1 and SFM2 of the first distance measuring period so as to enlarge the distance measurement range MRG. Furthermore, the second TDC code circulation period longer than the first TDC code circulation period and the remaining one first TDC code circulation period are provided in the two subframes SFM1 and SFM2 of the second distance measuring period. As a result, by providing the two subframes SFM1 and SFM2 in the frame FM, the distance measurement range MRG can be expanded while the distance measurement of two objects 101 and 102 is enabled. Therefore, it is possible to improve the distance measurement accuracy of the objects 101 and 102 while restraining an increase in load applied to generation of the histogram, and it is possible to expand the distance measurement range MRG while improving a frame rate.

### 7. Seventh Embodiment

In the first embodiment described above, the three subframes SFM0 to SFM2 are provided in the frame FM in a time-division manner, and the number of objects whose distance can be measured is two. In this seventh embodiment, it is possible to select a distance measuring mode in distance measurement in which a plurality of subframes is provided in a frame in a time-division manner.

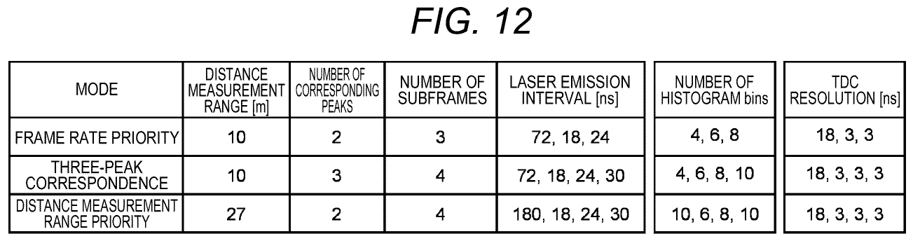

FIG. 12 is a diagram illustrating an example of distance measuring modes of a distance measuring device according to the seventh embodiment.

In the figure, as the distance measuring modes, a distance measuring device 100 is provided with a frame rate priority mode, a detectable peak number setting mode, and a distance measurement range priority mode. At this time, the distance measuring device 100 can use a light detection unit 123 for light detection. The frame rate priority mode is a mode corresponding to increasing a frame rate. The detectable peak number setting mode is a mode in which the number of objects whose distance can be measured can be switched to two or three. The distance measurement range priority mode is a mode corresponding to enlargement of a distance measurement range.

In accordance with the selection of the frame rate priority mode, the detectable peak number setting mode, and the distance measurement range priority mode, the distance measuring device 100 can switch a distance measurement range, the number of corresponding peaks, the number of subframes, and a laser emission interval. For example, in the frame rate priority mode, the distance measuring device 100 can execute the distance measurement processing of the first embodiment described above. In a case where three-peak correspondence is selected in the detectable peak number setting mode, the distance measuring device 100 can execute the distance measurement processing of the third embodiment described above. In a case where the distance measurement range priority mode is selected, the distance measuring device 100 can execute the distance measurement processing of the fourth embodiment described above.

At this time, the distance measuring device 100 may change a laser emission interval for every subframe in each of the frame rate priority mode, the detectable peak number setting mode, and the distance measurement range priority mode.

As described above, in the seventh embodiment described above, the frame rate priority mode, the detectable peak number setting mode, and the distance measurement range priority mode are provided as the distance measuring modes in the distance measuring device 100. As a result, the distance measuring device 100 can perform distance measurement while changing a distance measurement condition, and can achieve distance measurement adapted to a distance measurement environment.

### 8. Eighth Embodiment

In this seventh embodiment described above, it is possible to select the distance measuring mode in distance measurement in which a plurality of subframes is provided in a frame in a time-division manner. In this eighth embodiment, it is possible to select a distance measuring mode in distance measurement in which a plurality of subframes is provided in parallel in a frame.

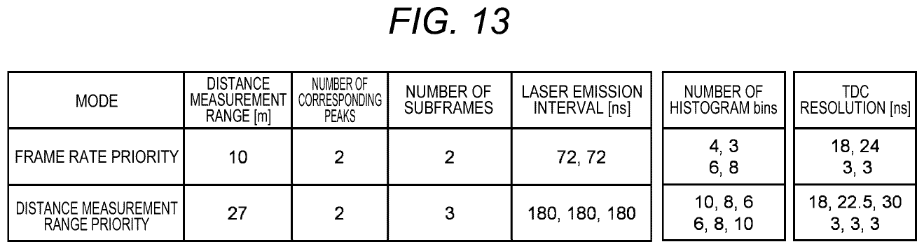

FIG. 13 is a diagram illustrating an example of distance measuring modes of a distance measuring device according to the eighth embodiment.

In the figure, as the distance measuring modes, a distance measuring device 100 is provided with a frame rate priority mode and a distance measurement range priority mode. At this time, the distance measuring device 100 can use a light detection unit 223 for light detection.

In accordance with the selection of the frame rate priority mode and the distance measurement range priority mode, the distance measuring device 100 can switch a distance measurement range, the number of corresponding peaks, the number of subframes, and a laser emission interval. For example, in the frame rate priority mode, the distance measuring device 100 can execute the distance measurement processing of the second embodiment described above. In a case where the distance measurement range priority mode is selected, the distance measuring device 100 can execute the distance measurement processing of the fifth embodiment described above or the distance measurement processing of the sixth embodiment described above.

As described above, in the eighth embodiment described above, the frame rate priority mode and the distance measurement range priority mode are provided as the distance measuring modes in the distance measuring device 100. As a result, the distance measuring device 100 can perform distance measurement while changing a distance measurement condition, and can achieve distance measurement adapted to a distance measurement environment.

### 9. Ninth Embodiment

In the first embodiment described above, the three subframes SFM0 to SFM2 are provided in the frame FM in a time-division manner, and the mutually different first TDC code circulation periods are set in the two subframes SFM1 and SFM2. In this ninth embodiment, an upper layer chip is provided with a pixel array section 140 in which pixels 151 are arranged, and a lower layer chip is provided with a circuit array section in which circuit sections are arranged.

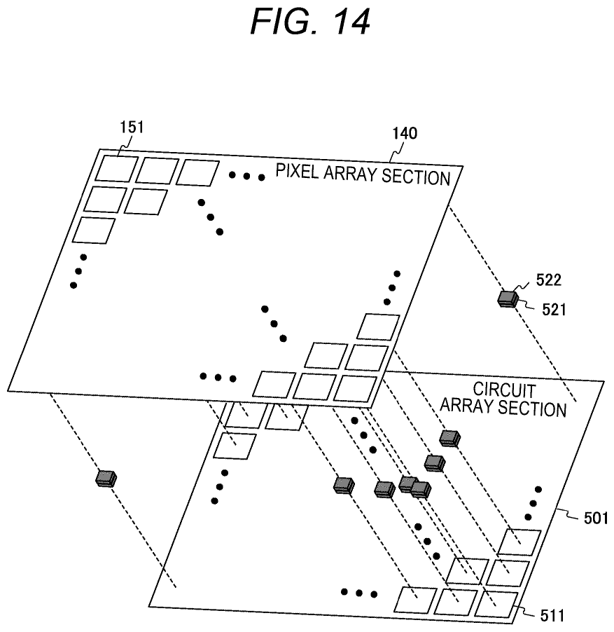

FIG. 14 is a perspective view illustrating a stacking example of a light detection unit according to the ninth embodiment.

In the figure, the light detection unit includes the pixel array section 140 and a circuit array section 501. The pixel array section 140 can be stacked on the circuit array section 501. The pixel array section 140 includes the pixels 151 and a readout circuit 132. The pixels 151 are arranged in a matrix in a row direction and a column direction. Each pixel 151 can be provided with a SPAD.

The circuit array section 501 includes circuit sections 511. The circuit sections 511 are arranged in a matrix in the row direction and the column direction. Each circuit section 511 can be provided for every pixel 151. Each circuit section 511 can be provided with a TDC 133, a histogram generation section 134, and the like.

The lower layer chip on which the circuit array section 501 is formed and the upper layer chip on which the pixel array section 140 is formed may be directly bonded. At this time, pad electrodes 521 and 522 can be formed on the lower layer chip and the upper layer chip, respectively. The pad electrode 521 is connected to the circuit section 511. The pad electrode 522 is connected to the readout circuit 132. The pad electrodes 521 and 522 can be disposed to face each other. For the direct bonding between the upper layer chip and the lower layer chip, hybrid bonding can be used. At this time, the pad electrodes 521 and 522 can be Cu-Cu connected.

As described above, in the ninth embodiment described above, the pixel array section 140 in which the pixels 151 are arranged is stacked on the circuit array section 501 in which the circuit sections 511 are arranged. As a result, it is possible to increase an area of the pixel 151 while restraining an increase in chip size, and it is possible to improve sensitivity while reducing a size of the solid-state imaging device.

### 10. Tenth Embodiment

In the ninth embodiment described above, the pixel array section 140 in which the pixels 151 are arranged is stacked on the circuit array section 501 in which the circuit sections 511 are arranged. In this tenth embodiment, an upper layer chip is provided with a pixel array section in which pixels each provided with a plurality of SPADs are arranged, and a lower layer chip is provided with a circuit array section in which circuit sections are arranged.

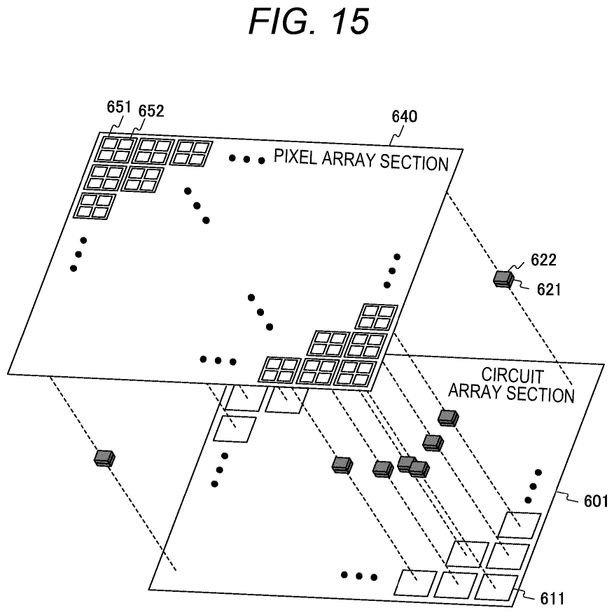

FIG. 15 is a perspective view illustrating a stacking example of a light detection unit according to the tenth embodiment.

In the figure, the light detection unit includes a pixel array section 640 and a circuit array section 601. The pixel array section 640 can be stacked on the circuit array section 601. The pixel array section 640 includes pixels 651 and a readout circuit 132. The pixels 651 are arranged in a matrix in a row direction and a column direction. Each pixel 651 can be provided with a plurality of SPADs 652. In each pixel 651, the SPADs 652 may be arranged in a matrix in a row direction and a column direction. In the figure, an example is illustrated in which the SPADs 652 are arranged in a matrix of two rows and two columns. In each pixel 651, the plurality of SPADs 652 can be connected in parallel.

The circuit array section 601 includes circuit sections 611. The circuit sections 611 are arranged in a matrix in the row direction and the column direction. Each circuit section 611 can be provided for every pixel 651. Each circuit section 611 can be provided with a TDC 133, a histogram generation section 134, and the like. At this time, the readout circuit 132 of each circuit section 611 can be connected to the plurality of SPADs 652 of each pixel 651.

The lower layer chip on which the circuit array section 601 is formed and the upper layer chip on which the pixel array section 640 is formed may be directly bonded. At this time, pad electrodes 621 and 622 can be formed on the lower layer chip and the upper layer chip, respectively. The pad electrode 621 is connected to the circuit section 611. The pad electrode 622 is connected to the readout circuit 132. The pad electrodes 621 and 622 can be disposed to face each other. For the direct bonding between the upper layer chip and the lower layer chip, hybrid bonding can be used. At this time, the pad electrodes 621 and 622 can be Cu-Cu connected.

As described above, in the tenth embodiment described above, the pixel array section 640 in which the pixels 651 each provided with the plurality of SPADs 652 are arranged is stacked on the circuit array section 601 in which the circuit sections 611 are arranged. As a result, it is possible to increase an area of each pixel 651 while restraining an increase in chip size, and it is possible to increase a frequency of light reception. It is therefore possible to improve sensitivity while downsizing the solid-state imaging device and increase the S/N ratio.

### 11. Example of Application to Mobile Object

The technology according to the present disclosure (the present technology) can be applied to various products. For example, the technology according to the present disclosure may also be implemented as a device mounted on any type of mobile body such as an automobile, an electric automobile, a hybrid electric automobile, a motorcycle, a bicycle, a personal mobility, an airplane, a drone, a ship, and a robot.

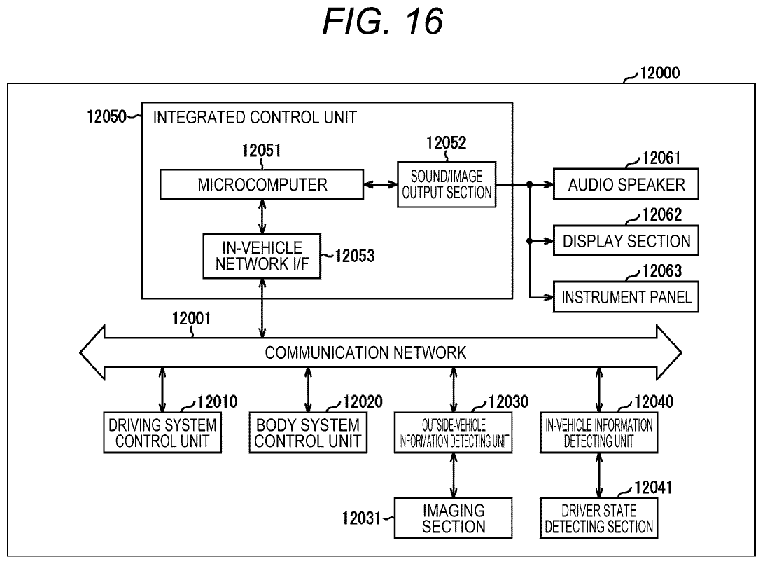

FIG. 16 is a block diagram illustrating an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example illustrated in FIG. 16, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and an in-vehicle network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. Furthermore, the light received by the imaging section 12031 may be visible light, or may be invisible light such as infrared rays.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the vehicle exterior information obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 16, an audio speaker 12061, a display section 12062, and an instrument panel 12063 are illustrated as the output device. The display section 12062 may, for example, include at least one of an on-board display and a head-up display.

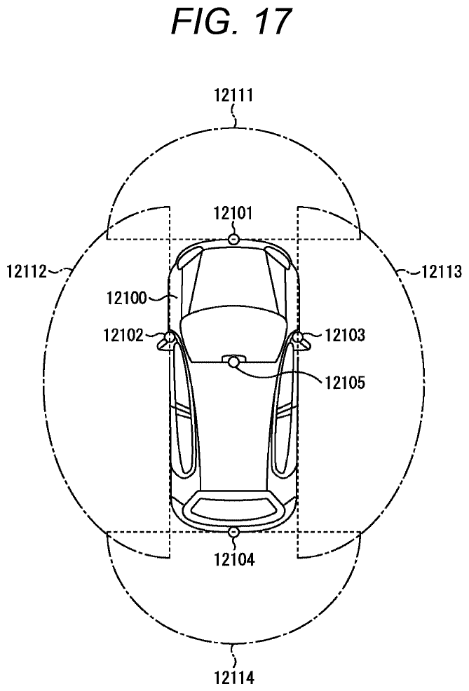

FIG. 17 is a diagram illustrating an example of the installation position of the imaging section 12031.

In FIG. 17, the imaging section 12031 includes imaging sections 12101, 12102, 12103, 12104, and 12105.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 17 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described. The technology of the present disclosure can be applied to the imaging section 12031 among the configurations described above. Specifically, for example, the distance measuring device 100 described above can be applied to the imaging section 12031. By applying the technology according to the present disclosure to the vehicle control system 12000, it is possible to expand a distance measurement range while restraining an increase in load applied to the distance measurement processing, and it is possible to improve the distance measurement accuracy of a plurality of objects 101 and 102.

Note that the embodiments described above are examples for embodying the present technology, and the matters in the embodiments and the matters specifying the invention in the claims have correspondences. Similarly, the matters specifying the invention in the claims and the matters with the same names in the embodiments of the present technology have correspondences. The present technology, however, is not limited to the embodiments, and can be implemented by modifying the embodiments in various ways without departing from the scope thereof.

Furthermore, the effects described in the present specification are merely examples and not restrictive, and other effects may also be produced.

Note that the present technology can also have the following configurations.
(1) A photodetection device including:
a time to digital converter (TDC) configured to measure a time of a light reception timing of a photon;
a histogram generation section configured to generate histograms having TDC resolutions that are mutually different in TDC code circulation periods of the TDC that are mutually different; and
a distance calculation unit configured to calculate a distance to an object on the basis of a histogram generated by the histogram generation section.
(2) The photodetection device according to (1) above, in which
the TDC measures a time of light reception timings of the photons having mutually different light emission intervals.
(3) The photodetection device according to (1) or (2) above, in which
the histogram generation section
generates two or more first histograms having, among the TDC code circulation periods, mutually different TDC code circulation periods in a first distance measuring period, and
generates a second histogram having, among the TDC resolutions, a TDC resolution coarser than a TDC resolution of each of the first histograms, in a second distance measuring period.
(4) The photodetection device according to (3) above, in which
a light emission interval of distance measurement light in the first distance measuring period is shorter than a light emission interval of the distance measurement light in the second distance measuring period.
(5) The photodetection device according to (3) or (4) above, in which
a light emission interval of the distance measurement light in the first distance measuring period is an integral multiple of each of the TDC code circulation periods for the first histograms.
(6) The photodetection device according to any one of (3) to (5) above, in which
a bin width that is a TDC resolution of a histogram of the second distance measuring period is equal to or smaller than each of the TDC code circulation periods for the first histograms.
(7) The photodetection device according to any one of (3) to (6) above, in which
a TDC code of the TDC circulates a plurality of times within a distance measurement range in the first distance measuring period.
(8) The photodetection device according to any one of (3) to (7) above, in which
the TDC resolutions of the two or more first histograms are equal to each other.
(9) The photodetection device according to any one of (3) to (8) above, in which
an upper limit of a bin width that is the TDC resolution of a histogram in the second distance measuring period is a minimum value of the TDC code circulation periods for the first histograms.
(10) The photodetection device according to (9) above, in which
a lower limit of a bin width that is the TDC resolution of a histogram in the second distance measuring period is a value obtained by dividing a distance measurement range by a maximum value of a number of bins of the second histogram.
(11) The photodetection device according to any one of (3) to (10) above, in which
the first distance measuring period and the second distance measuring period are set in a time-division manner.
(12) The photodetection device according to (11) above, in which
a same circuit resource is allocated to generation of the first histograms and generation of the second histogram.
(13) The photodetection device according to any one of (3) to (10) above, in which
the first distance measuring period and the second distance measuring period are set in parallel.
(14) The photodetection device according to (13) above, in which
separate circuit resources are allocated to generation of the first histograms and generation of the second histogram.
(15) The photodetection device according to any one of (1) to (14) above, in which
at least one mode is provided from among a frame rate priority mode in which a frame rate can be increased, a detectable peak number setting mode in which a number of detectable peaks can be increased, and a distance measurement range priority mode in which a distance measurement range can be expanded.
(16) The photodetection device according to (15) above, in which
a light emission interval of the distance measurement light is changed for every subframe in at least one of the frame rate priority mode, the detectable peak number setting mode, or the distance measurement range priority mode.
(17) The photodetection device according to (3), further including:
a distance calculation unit configured to calculate a distance to an object on the basis of a histogram generated by the histogram generation section.
(18) The photodetection device according to (17) above, in which
the distance calculation unit calculates a distance to at least one object on the basis of the first histograms and the second histogram.
(19) The photodetection device according to (17) or (18) above, in which
a number of distances to an object that can be calculated by the distance calculation unit is equal to or smaller than a number of the first histograms.
(20) A distance measuring system including:
a light emitting unit configured to emit a photon to an object; and
a photodetection device configured to generate histograms having mutually different time to digital converter (TDC) resolutions in mutually different TDC code circulation periods of a TDC that measures a time of a light reception timing of a photon reflected from the object.

### REFERENCE SIGNS LIST

100 Distance measuring device
101, 102 Object
111 Drive unit
112 Light emitting unit
113, 121 Optical system
122 Optical filter
123 Light detection unit
124 Distance calculation unit
131 Pixel array section
132 Readout circuit
133 TDC
134 Histogram generation section
135 Control unit
131 Pixel array section
141 Row scanning circuit
142 Column processing circuit
151 Pixel
152 Switch

1. A photodetection device comprising:
a time to digital converter (TDC) configured to measure a time of a light reception timing of a photon; and
a histogram generation section configured to generate histograms having TDC resolutions that are mutually different in TDC code circulation periods of the TDC that are mutually different.

2. The photodetection device according to claim 1, wherein
the TDC measures a time of light reception timings of the photons having mutually different light emission intervals.

3. The photodetection device according to claim 1, wherein
the histogram generation section
generates two or more first histograms having, among the TDC code circulation periods, mutually different TDC code circulation periods in a first distance measuring period, and
generates a second histogram having, among the TDC resolutions, a TDC resolution coarser than a TDC resolution of each of the first histograms, in a second distance measuring period.

4. The photodetection device according to claim 3, wherein
a light emission interval of distance measurement light in the first distance measuring period is shorter than a light emission interval of the distance measurement light in the second distance measuring period.

5. The photodetection device according to claim 3, wherein
a light emission interval of the distance measurement light in the first distance measuring period is an integral multiple of each of the TDC code circulation periods for the first histograms.

6. The photodetection device according to claim 3, wherein
a bin width that is a TDC resolution of a histogram of the second distance measuring period is equal to or smaller than each of the TDC code circulation periods for the first histograms.

7. The photodetection device according to claim 3, wherein
a TDC code of the TDC circulates a plurality of times within a distance measurement range in the first distance measuring period.

8. The photodetection device according to claim 3, wherein
the TDC resolutions of the two or more first histograms are equal to each other.

9. The photodetection device according to claim 3, wherein
an upper limit of a bin width that is the TDC resolution of a histogram in the second distance measuring period is a minimum value of the TDC code circulation periods for the first histograms.

10. The photodetection device according to claim 9, wherein
a lower limit of a bin width that is the TDC resolution of a histogram in the second distance measuring period is a value obtained by dividing a distance measurement range by a maximum value of a number of bins of the second histogram.

11. The photodetection device according to claim 3, wherein
the first distance measuring period and the second distance measuring period are set in a time-division manner.

12. The photodetection device according to claim 11, wherein
a same circuit resource is allocated to generation of the first histograms and generation of the second histogram.

13. The photodetection device according to claim 3, wherein
the first distance measuring period and the second distance measuring period are set in parallel.

14. The photodetection device according to claim 13, wherein
separate circuit resources are allocated to generation of the first histograms and generation of the second histogram.

15. The photodetection device according to claim 1, wherein
at least one mode is provided from among a frame rate priority mode in which a frame rate can be increased, a detectable peak number setting mode in which a number of detectable peaks can be increased, and a distance measurement range priority mode in which a distance measurement range can be expanded.

16. The photodetection device according to claim 15, wherein
a light emission interval of the distance measurement light is changed for every subframe in at least one of the frame rate priority mode, the detectable peak number setting mode, or the distance measurement range priority mode.

17. The photodetection device according to claim 3, further comprising:
a distance calculation unit configured to calculate a distance to an object on a basis of a histogram generated by the histogram generation section.

18. The photodetection device according to claim 17, wherein
the distance calculation unit calculates a distance to at least one object on a basis of the first histograms and the second histogram.

19. The photodetection device according to claim 17, wherein
a number of distances to an object that can be calculated by the distance calculation unit is equal to or smaller than a number of the first histograms.

20. A distance measuring system comprising:
a light emitting unit configured to emit a photon to an object; and
a photodetection device configured to generate histograms having mutually different time to digital converter (TDC) resolutions in mutually different TDC code circulation periods of a TDC that measures a time of a light reception timing of a photon reflected from the object.
